(19) United States
(12) Patent Application Publication
(10) Pub. No.: US 2021/0201398 A1
(43) Pub. Date: Jul. 1, 2021

(54) SWITCH SERVER INTEGRATED SYSTEMS PROVIDING SECURE COMMUNICATIONS FOR ONE-CLICK ADVICE AND TRANSACTIONS

(71) Applicant: ForUsAll, Inc., San Carlos, CA (US)

(72) Inventors: Holly Brotherton, San Francisco, CA (US); Philip Donor Balliet, Novato, CA (US); Chenxing Guo, Foster City, CA (US); Haotian Lyu, San Francisco, CA (US); Yen-Hsuan Chen, San Francisco, CA (US); Benjamin Otto Werdmuller, Santa Rosa, CA (US); Neeraj Kumar Mathur, Los Altos, CA (US)

(21) Appl. No.: 17/134,495

(22) Filed: Dec. 27, 2020

Related U.S. Application Data
(60) Provisional application No. 62/955,973, filed on Dec. 31, 2019.

(51) Int. Cl. G06Q 40/02; G06Q 40/06; G06Q 40/00; G06Q 20/10; G06F 21/33

(52) U.S. Cl. CPC G06Q 40/02; G06Q 40/06; G09B 19/18; G06Q 20/102; G06F 21/33; G06Q 40/125

(57) ABSTRACT

The disclosure relates to systems and methods for one-click transactions and financial advice using integrated systems. In exemplary embodiments a system includes at least one gateway server electronically communicating with a secure switch and including a processor and a memory communicatively coupled to the processor, the memory storing instructions executable by the system to perform operations, the operations comprising: receiving a plurality of data sources of a validated participant including payroll data and retirement account data of the validated participant; sending a call-to-action message to the validated participant based on analyzing of the plurality of data sources of the validated participant including the payroll data and the retirement account data of the validated participant; automatically implementing advice for the validated participant by automatically communicating with the at least one investment service provider (ISP) and at least one payroll service provider (PSP) based on the feedback from the validated participant.

### CROSS REFERENCE TO RELATED APPLICATION

This application claims the priority benefit of U.S. Provisional Patent Application Ser. No. 62/955,973 filed on Dec. 31, 2019, which is hereby incorporated by reference in its entirety for all purposes.

### FIELD OF INVENTION

The present technology pertains to integrated systems for transactions by a participant. In particular, but not by way of limitation, the present technology provides integrated systems for one-click advice and transactions for the participant.

### SUMMARY

According to some embodiments, the present technology is directed to a system for one-click transactions and financial advice using integrated systems. In some embodiments the system comprises: a secure switch operable to communicate bilaterally with at least one financial service provider (FSP); at least one gateway server electronically communicating with the secure switch and including a processor and a memory communicatively coupled to the processor, the memory storing instructions executable by the system to perform operations, the operations comprising: exchanging cryptographic information with a computing device associated with a prospective participant, the cryptographic information adapted to encrypt and decrypt communications; receiving, from the prospective participant, identifying information associated with the prospective participant; validating the identifying information using the cryptographic information; converting the prospective participant to a validated participant after the validating operation; receiving a plurality of data sources of the validated participant including payroll data and retirement account data of the validated participant; sending a call-to-action message to the validated participant based on analyzing of the plurality of data sources of the validated participant including the payroll data and the retirement account data of the validated participant; receiving feedback from the validated participant based on the call-to-action message; and automatically implementing advice for the validated participant by automatically communicating with at least one of the at least one financial service provider (FSP) and the at least one banking service provider (BSP) based on the feedback from the validated participant; and at least one application programming interface electronically communicating with the at least one gateway server and adapted to communicate bilaterally with a participant application being executed on the computing device. In various embodiments the at least one financial service provider (FSP) is an Investment Service Provider (ISP) such as company providing investment advice. In various embodiments the at least one banking service provider (BSP) is a payroll service provider (PSP), a bank, or other service provider that has access to a financial account of the participant.

In various embodiments the automatically implementing advice for the validated participant by automatically communicating with at least one of the at least one financial service provider (FSP) and the at least one banking service provider (BSP) comprises: sending an automatically implement advice for the participant file to the at least one financial service provider (FSP); receiving an automatically implemented advice for the participant confirmation file from the at least one financial service provider (FSP); sending the automatically implement advice for the participant file to the at least one banking service provider (BSP); and updating a transaction status of the validated participant using the participant application being executed on the computing device.

In some embodiments the receiving feedback from the validated participant based on the call-to-action message comprises a first change in a savings percentage for the retirement account data of the validated participant including a first participant feedback timestamp.

In various embodiments the operations further comprise: saving the first change in the savings percentage for the retirement account data of the validated participant including the first participant feedback timestamp in a database; receiving a second change in the savings percentage for the retirement account data of the validated participant including a second participant feedback timestamp from the at least one financial service provider (FSP); and comparing the first participant feedback timestamp and the second participant feedback timestamp to determine a most recent timestamp.

In some embodiments the first participant feedback timestamp is the most recent timestamp determined by the comparing the first participant feedback timestamp and the second participant feedback timestamp; wherein the automatically implementing advice for the validated participant by automatically communicating with at least one of the at least one financial service provider (FSP) and the at least one banking service provider (BSP) comprises: sending the first change in the savings percentage for the retirement account data of the validated participant including the first participant feedback timestamp to the at least one banking service provider (BSP).

In various embodiments the second participant feedback timestamp is the most recent timestamp determined by the comparing the first participant feedback timestamp and the second participant feedback timestamp; wherein the automatically implementing advice for the validated participant by automatically communicating with at least one of the at least one financial service provider (FSP) and the at least one banking service provider (BSP) comprises: sending the second change in the savings percentage for the retirement account data of the validated participant including the second participant feedback timestamp to the at least one banking service provider (BSP).

In some embodiments the operations further comprise: initiating a one-time or recurring transaction from the at least one banking service provider (BSP) by streamlining a Know-Your-Customer (KYC) process using known data of the validated participant, the known data of the validated participant including financial data of the validated participant available as a financial advisor of the validated participant and authority data from the validated participant; identifying transactions-in-progress of the validated participant, the transactions-in-progress of the validated participant comprising when funds are in-transition between the at least one financial service provider (FSP) and the at least one banking service provider (BSP); and sending a transition notification to the validated participant using the identifying transactions-in-progress of the validated participant using the participant application being executed on the computing device, the transition notification comprising a call-to-action message to the validated participant about the transactions-in-progress before the transactions are completed.

In various embodiments the one-time or recurring transaction from the at least one banking service provider (BSP) comprises at least one or more of: opening a savings account in a name of the validated participant at the at least one financial service provider (FSP) using funds transferred by the at least one banking service provider (BSP) and establishing a one-off or recurring withdrawal from a checking account of the validated participant.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified block diagram of a system according to exemplary embodiments of the present technology.

FIG. 2 is a schematic diagram of an exemplary computing architecture that can be used to practice aspects of the present technology.

FIG. 3 is a flow diagram illustrating an example method according to exemplary embodiments of the present technology.

FIG. 4 is another flow diagram showing a further example according to exemplary embodiments of the present technology.

FIG. 5 illustrates a computer system according to exemplary embodiments of the present technology.

### DETAILED DESCRIPTION

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

Embodiments of the present technology provide systems and methods to reduce friction involved in implementing financial advice, including signing-up and changing savings elections for participants into a retirement savings plan or other types of accounts. Systems and methods use one-click functionality using integrated systems.

In various embodiments the present technology includes identifying transactions-in-progress of the participant. In some embodiments, the transactions-in-progress of the participant include when funds are in-transition between accounts. For example, the transactions-in-progress of the participant may include a “transition” state in which money is in-transfer between a payroll account and a bank account of the participant. In various embodiments methods of the present technology further include sending a transition notification to the participant using the identifying transactions-in-progress of the participant. For example, the transition notification may include a call-to-action message to the participant about the transactions-in-progress before the transactions-in-progress are completed.

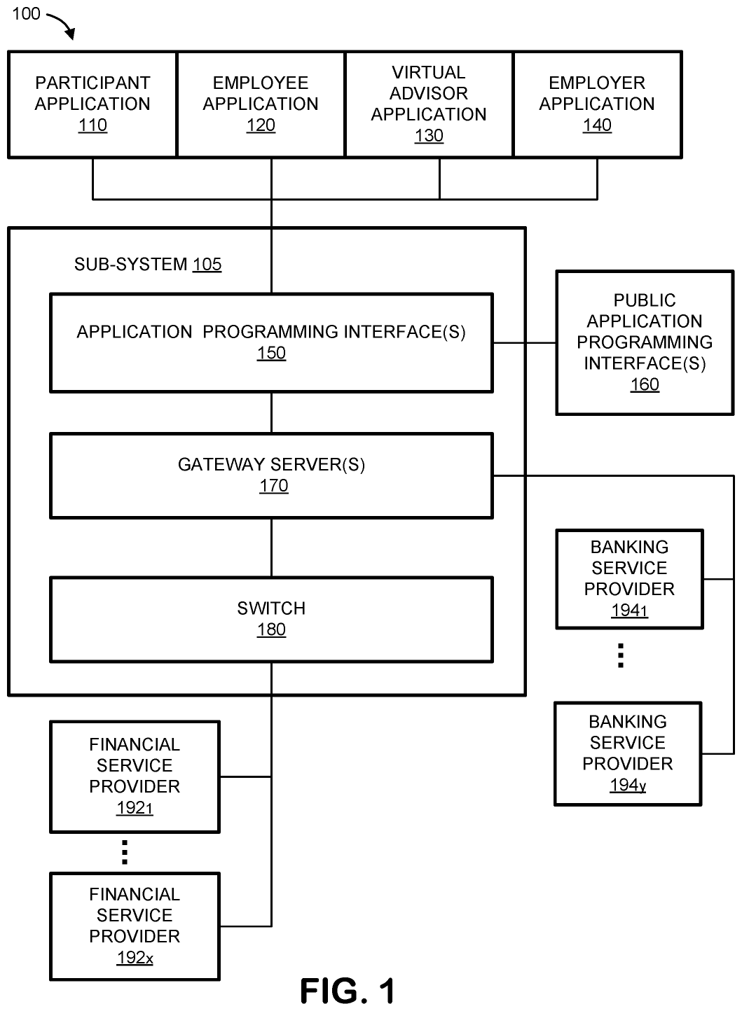

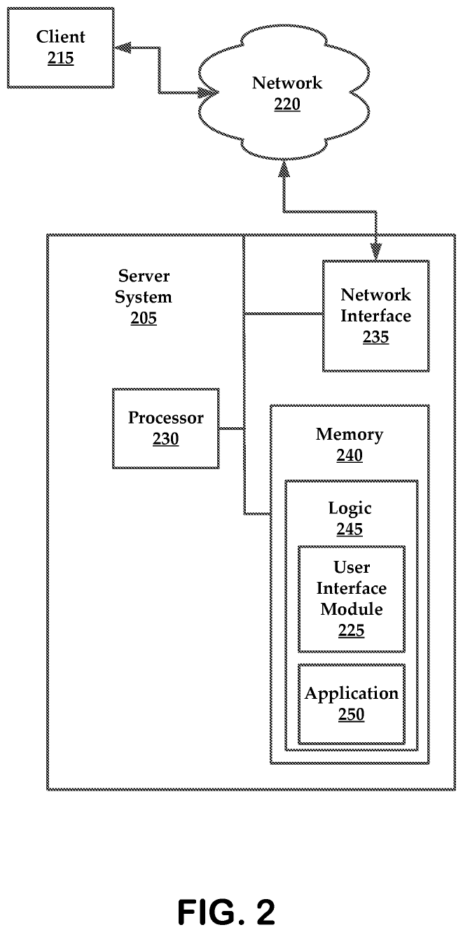

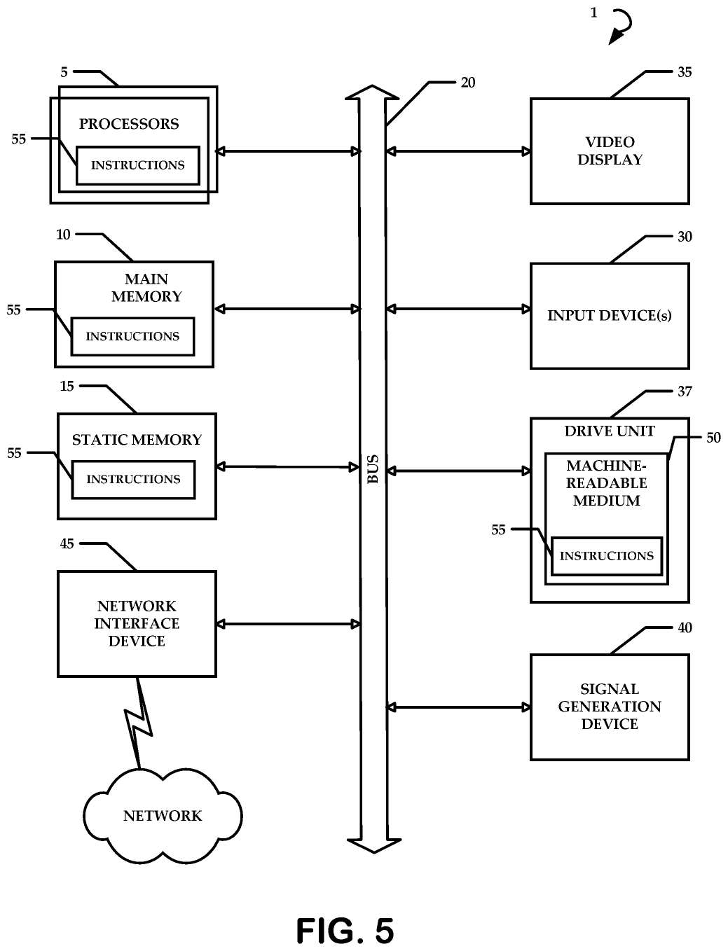

FIG. 1 is a simplified block diagram of a system 100 according to exemplary embodiments of the present technology. The architecture comprises a server system that is configured to provide various functionalities, which are described in greater detail throughout this document. Generally, the system 100 is configured to communicate with client devices. Client devices may include, for example, a Smartphone, a laptop, a computer, or other similar computing device. An example of a computing device that can be utilized in accordance with the present technology is described in greater detail with respect to FIG. 2 and FIG. 5.

The system 100 may communicatively couple with clients via a public or private network. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection, and the like. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network, and the like. A network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital, or analog interface or connection, mesh or Digi® networking, and the like.

The system 100 in FIG. 1 generally comprises participant application 110, employee application 120, virtual advisor 130, and employer application 140. The system 100 further includes application programming interface(s) 150, public application programming interface(s) 160, gateway server(s) 170, and switch 180. Application programming interface(s) 150, gateway server(s) 170, and switch 180 form sub-system 105, which may also be referred to as the internal secure system. Participant application 110, employee application 120, virtual advisor 130, and employer application 140 may communicate bilaterally with gateway server(s) 170 via application programming interface(s) 150. System 100 also includes financial service provider (FSP) (FSPs) 192₁-192ₓ and banking service provider (BSPs) 194₁-194_{y}. In various embodiments banking service provider (BSPs) 194₁-194_{y} include a payroll service provider (PSP), banking service providers such as a bank, or other service providers that have access to a financial account of the participant.

Financial service provider (FSPs) 192₁-192ₓ may communicate bilaterally with gateway server(s) 170 via switch 180. Financial service provider (FSPs) 192₁-192ₓ may include an investment service provider (ISP) such as an investment company. For example, Vanguard, Fidelity Investments, and the like. Furthermore, investment service providers (ISPs) may be an investment service provider operating on behalf of the investment company. Financial service provider (FSPs) 192₁-192ₓ may also be other financial service providers such as health saving account provider. Banking service providers (BSPs) 194₁-194_{y}-194₁-194_{y} may bilaterally communicate directly with gateway server(s) 170. Banking service provider (BSPs) 194₁-194_{y} include financial institutions such as a bank and may also include payroll service providers such as online payroll service providers including PAYCHEX, ADP, and the like, that provide payroll services for employers to employees.

FIG. 2 illustrates an exemplary architecture for practicing aspects of the present technology. The architecture comprises a server system, hereinafter “system 205” that is configured to provide various functionalities, which are described in greater detail throughout this document. Generally, the system 205 is configured to communicate with client devices, such as client 215. An example of a computing device that can be utilized in accordance with the present technology is described in greater detail with respect to FIG. 5.

The system 205 may communicatively couple with the client 215 via a public or private network, such as network 220. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 220 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital, or analog interface or connection, mesh or Digi® networking.

The system 205 generally comprises a processor, 230, a network interface 235, and a memory 240. According to some embodiments, the memory 240 comprises logic (e.g., instructions) 245 that can be executed by the processor 230 to perform various methods and operations. For example, the logic may include a user interface module 225 as well as a data aggregation and correlation application (hereinafter application 250) that is configured to provide the functionalities described in greater detail herein including enabling one-click transactions for a participant using integrated systems. For example, application 250 may comprise participant application 110, employee application 120, virtual advisor 130, and employer application 140.

It will be understood that the functionalities described herein, which are attributed to the system 205 and the application 250 may also be executed within the client 215. That is, the client 215 may be programmed to execute the functionalities described herein. In other instances, the system 205 and client 215 may cooperate to provide the functionalities described herein, such that the client 215 is provided with a client-side application that interacts with the system 205 such that the system 205 and client 215 operate in a client/server relationship. Complex computational features may be executed by the system 205, while simple operations that require fewer computational resources may be executed by the client 215, such as data gathering and data display.

In general, the user interface module 225 may be executed by the system 205 to provide various graphical user interfaces (GUIs) that allow participants to interact with the system 205. For example, a customizable interface on a device for enabling one-click advice for a participant using integrated systems. In some instances, GUIs are generated by execution of the application 250 itself. Participants may interact with the system 205 using, for example, a client 215. The system 205 may generate web-based interfaces for the client.

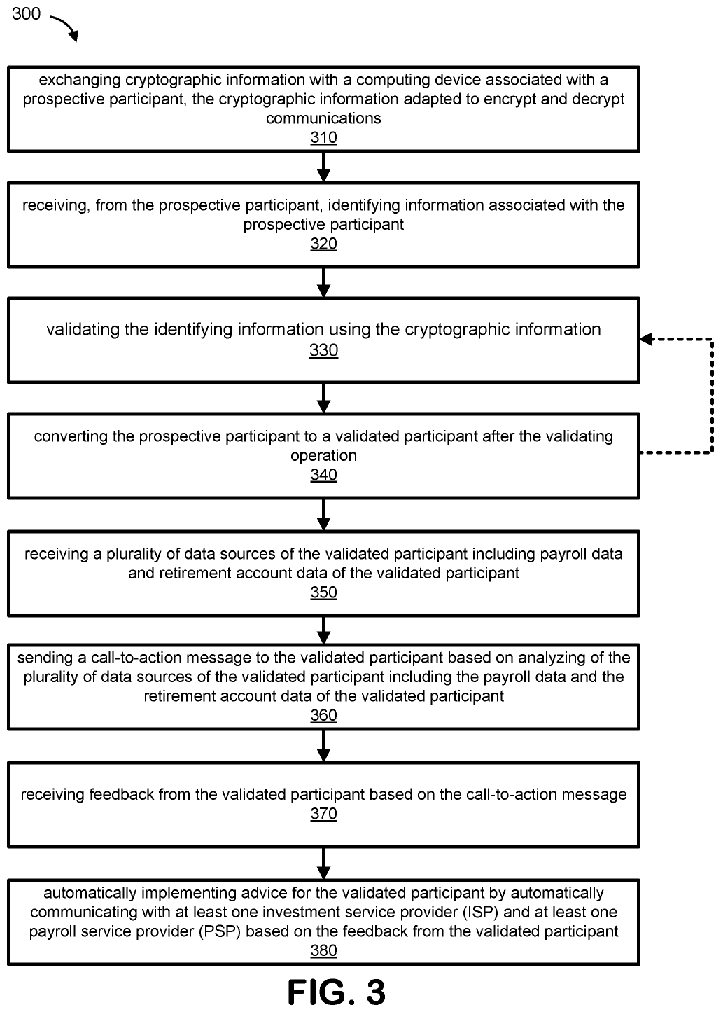

FIG. 3 is a flow diagram illustrating an example method according to exemplary embodiments of the present technology. The method 300 may be a computer-implemented method of secure transactions for one-click transactions and financial advice using one or more gateway servers. The method 300 of FIG. 3 may be performed by processing logic that may comprise hardware (e.g., dedicated logic, programmable logic, and microcode), software (such as software run on a general-purpose computer system or a dedicated machine), or a combination thereof.

As shown in FIG. 3, the exemplary method 300 may commence at operation 310, exchanging cryptographic information with a computing device associated with a prospective participant, the cryptographic information adapted to encrypt and decrypt communications. At operation 320, the method 300 may proceed with receiving, from the prospective participant, identifying information associated with the prospective participant. In some instances, the computing device associated with a prospective participant is a mobile device such as a Smartphone.

At operation 330, the method 300 may proceed with validating the identifying information using the cryptographic information. At operation 340, the method 300 may proceed with converting the prospective participant to a validated participant after the validating operation.

At operation 350, the method 300 may proceed with receiving a plurality of data sources of the validated participant including payroll data and retirement account data of the validated participant. At operation 360, the method 300 may proceed with sending a call-to-action message to the validated participant based on analyzing of the plurality of data sources of the validated participant including the payroll data and the retirement account data of the validated participant.

At operation 370, the method 300 may proceed with receiving feedback from the validated participant based on the call-to-action message. At operation 380, the method 300 may proceed with automatically implementing advice for the validated participant by automatically communicating with at least one investment service provider (ISP) and at least one payroll service provider (PSP) based on the feedback from the validated participant.

For example, in exemplary embodiments the method 300 may be a computer-implemented method of secure transactions for one-click transactions and financial advice using one or more gateway servers and may include one-click transactions using integrated systems of the present technology. In various embodiments the method includes analyzing multiple points of data including, but not limited to payroll data for a participant. For example, when a participant gets paid, the payroll data of the participant may be downloaded. In some embodiments the method includes sending a call-to action message to the participant using the analysis of payroll data and 401(k) data of the participant. For example, based on the participant's 401(k) plan rules and the participants payroll data, a targeted advisory message (e.g., an electronic mail message) may be sent to the participant with a call-to-action to implement the advice. If the participant clicks on the call-to-action, then the system will update both the payroll system and the 401(k) system to affect the advice based on that single click. This replaces the traditional system that requires the participant to login to the 401(k) system and change his/her deferral election and subsequently having a separate entity update the payroll system to affect the deferral rate change. In some embodiments the method includes capturing feedback from the participant using a call-to-action message; updating savings election of the participant using feedback captured from the participant; and auto-updating savings deduction of the participant at a payroll provider using the capturing feedback from the participant.

In some embodiments the automatically implementing advice for the validated participant by automatically communicating with the at least one investment service provider (ISP) and the at least one payroll service provider (PSP) comprises: sending an automatically implement advice for the participant file to the at least one investment service provider (ISP); receiving an automatically implemented advice for the participant confirmation file from the at least one investment service provider (ISP); sending the automatically implement advice for the participant file to the at least one payroll service provider (PSP); and updating a transaction status of the validated participant using a participant application being executed on the computing device.

In some embodiments the receiving feedback from the validated participant based on the call-to-action message comprises a first change in a savings percentage for the retirement account data of the validated participant including a first participant feedback timestamp.

In various embodiments the operations further comprise: saving the first change in the savings percentage for the retirement account data of the validated participant including the first participant feedback timestamp in a database; receiving a second change in the savings percentage for the retirement account data of the validated participant including a second participant feedback timestamp from the at least one investment service provider (ISP); and comparing the first participant feedback timestamp and the second participant feedback timestamp to determine a most recent timestamp.

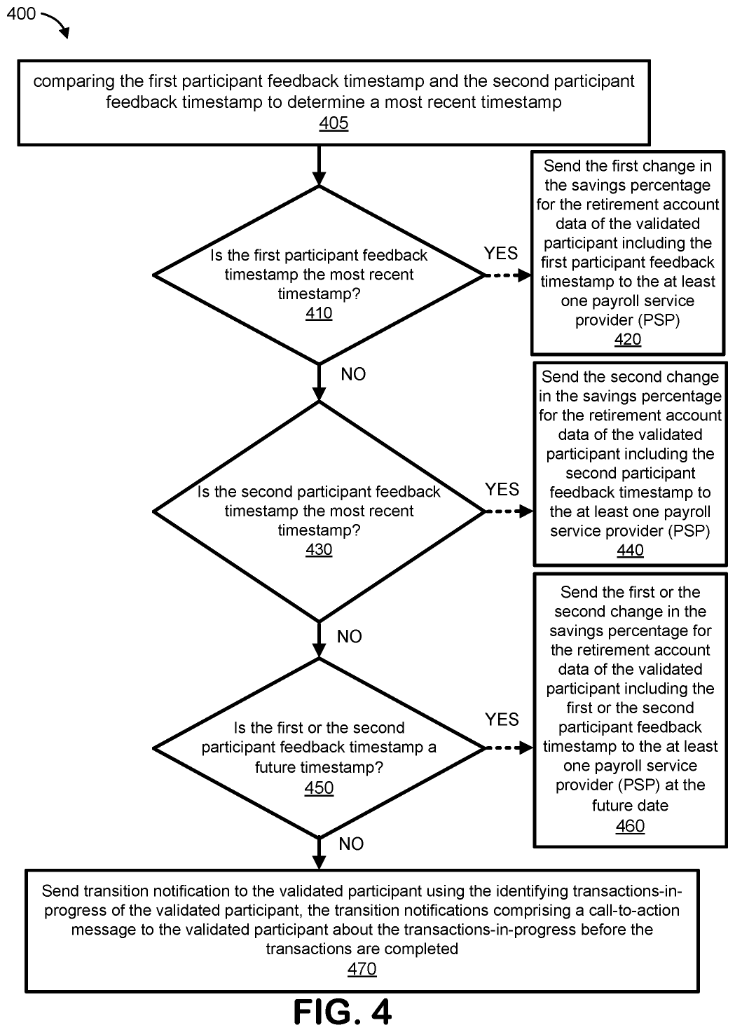

FIG. 4 is another flow diagram showing a further example according to exemplary embodiments of the present technology. In various embodiments, method 400 is performed by a computing system, as described in relation to FIG. 5. The method 400 of FIG. 4 may be performed by processing logic that may comprise hardware (e.g., dedicated logic, programmable logic, and microcode), software (such as software run on a general-purpose computer system or a dedicated machine), or a combination thereof.

As shown in FIG. 4, the method 400 may commence at operation 405, comparing the first participant feedback timestamp and the second participant feedback timestamp to determine a most recent timestamp.

At step 410, a decision is made whether the first participant feedback timestamp is the most recent timestamp—is the first participant feedback timestamp the most recent timestamp? If yes, at step 420 the first change in the savings percentage for the retirement account data of the validated participant including the first participant feedback timestamp to the at least one payroll service provider (PSP) is sent. If no, at step 430 a decision is made whether the second participant feedback timestamp is the most recent timestamp—Is the second participant feedback timestamp the most recent timestamp?

If yes, at step 440 the second change in the savings percentage for the retirement account data of the validated participant including the second participant feedback timestamp to the at least one payroll service provider (PSP) is sent. If no, at step 450 a decision is made whether the first or the second participant feedback timestamp a future timestamp—is the first or the second participant feedback timestamp a future timestamp?

If yes, at step 460 the first or the second change in the savings percentage for the retirement account data of the validated participant including the first or the second participant feedback timestamp to the at least one payroll service provider (PSP) is sent at the future date. If no, at step 470 a transition notification to the validated participant using the identifying transactions-in-progress of the validated participant, the transition notification comprising a call-to-action message to the validated participant about the transactions-in-progress before the transactions are completed is sent.

In some embodiments the first participant feedback timestamp is the most recent timestamp determined by the comparing the first participant feedback timestamp and the second participant feedback timestamp; wherein the automatically implementing advice for the validated participant by automatically communicating with the at least one investment service provider (ISP) and the at least one payroll service provider (PSP) comprises: sending the first change in the savings percentage for the retirement account data of the validated participant including the first participant feedback timestamp to the at least one payroll service provider (PSP).

In various embodiments the second participant feedback timestamp is the most recent timestamp determined by the comparing the first participant feedback timestamp and the second participant feedback timestamp; wherein the automatically implementing advice for the validated participant by automatically communicating with the at least one investment service provider (ISP) and the at least one payroll service provider (PSP) comprises: sending the second change in the savings percentage for the retirement account data of the validated participant including the second participant feedback timestamp to the at least one payroll service provider (PSP).

In some embodiments the operations further comprise initiating a one-time or recurring transaction from the at least one payroll service provider (PSP) by streamlining a Know-Your-Customer (KYC) process using known data of the validated participant, the known data of the validated participant including financial data of the validated participant available as a financial advisor of the validated participant and authority data from the validated participant; identifying transactions-in-progress of the validated participant, the transactions-in-progress of the validated participant comprising when funds are in-transition between the at least one investment service provider (ISP) and the at least one payroll service provider (PSP); and sending a transition notification to the validated participant using the identifying transactions-in-progress of the validated participant and using a participant application being executed on the computing device, the transition notification comprising a call-to-action message to the validated participant about the transactions-in-progress before the transactions are completed.

In various embodiments the one-time or recurring transaction from the at least one payroll service provider (PSP) comprises at least one or more of: opening a savings account in a name of the validated participant at the at least one investment service provider (ISP) using funds transferred by the at least one payroll service provider (PSP) and establishing a one-off or recurring withdrawal from a checking account of the validated participant.

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 220, see FIG. 2) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

While various embodiments have been described above, it should be understood that they have been presented by way of example only, and not limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A system for one-click transactions and financial advice using integrated systems, the system comprising:
a secure switch operable to communicate bilaterally with at least one financial service provider (FSP); and
at least one gateway server electronically communicating with the secure switch and including a processor and a memory communicatively coupled to the processor, the memory storing instructions executable by the system to perform operations, the operations comprising:
exchanging cryptographic information with a computing device associated with a prospective participant, the cryptographic information adapted to encrypt and decrypt communications;
receiving, from the prospective participant, identifying information associated with the prospective participant;
validating the identifying information using the cryptographic information;
converting the prospective participant to a validated participant after the validating operation;
receiving a plurality of data sources of the validated participant including payroll data and retirement account data of the validated participant;
sending a call-to-action message to the validated participant based on analyzing of the plurality of data sources of the validated participant including the payroll data and the retirement account data of the validated participant;
receiving feedback from the validated participant based on the call-to-action message; and
automatically implementing advice for the validated participant by automatically communicating with at least one of: at least financial service provider (FSP) and at least one banking service provider (BSP) based on the feedback from the validated participant; and
at least one application programming interface electronically communicating with the at least one gateway server and adapted to communicate bilaterally with a participant application being executed on the computing device.

2. The system of claim 1, wherein the automatically implementing advice for the validated participant by automatically communicating with at least one of the at least one financial service provider (FSP) and the at least one banking service provider (BSP) comprises:
sending an automatically implement advice for the participant file to the at least one financial service provider (FSP);
receiving an automatically implemented advice for the participant confirmation file from the at least one financial service provider (FSP);
sending the automatically implement advice for the participant file to the at least one banking service provider (BSP); and
updating a transaction status of the validated participant using the participant application being executed on the computing device.

3. The system of claim 1, wherein the receiving feedback from the validated participant based on the call-to-action message comprises a first change in a savings percentage for the retirement account data of the validated participant including a first participant feedback timestamp.

4. The system of claim 3, wherein the operations further comprise:
saving the first change in the savings percentage for the retirement account data of the validated participant including the first participant feedback timestamp in a database;
receiving a second change in the savings percentage for the retirement account data of the validated participant including a second participant feedback timestamp from the at least one financial service provider (FSP); and
comparing the first participant feedback timestamp and the second participant feedback timestamp to determine a most recent timestamp.

5. The system of claim 4, wherein the first participant feedback timestamp is the most recent timestamp determined by the comparing the first participant feedback timestamp and the second participant feedback timestamp;
wherein the automatically implementing advice for the validated participant by automatically communicating with at least one of the at least one financial service provider (FSP) and the at least one banking service provider (BSP) comprises:
sending the first change in the savings percentage for the retirement account data of the validated participant including the first participant feedback timestamp to the at least one banking service provider (BSP).

6. The system of claim 4, wherein the second participant feedback timestamp is the most recent timestamp determined by the comparing the first participant feedback timestamp and the second participant feedback timestamp;
wherein the automatically implementing advice for the validated participant by automatically communicating with at least one of the at least one financial service provider (FSP) and the at least one banking service provider (BSP) comprises:
sending the second change in the savings percentage for the retirement account data of the validated participant including the second participant feedback timestamp to the at least one financial service provider (FSP).

7. The system of claim 1, the operations further comprise:
initiating a one-time or recurring transaction from the at least one banking service provider (BSP) by streamlining a Know-Your-Customer (KYC) process using known data of the validated participant, the known data of the validated participant including financial data of the validated participant available as a financial advisor of the validated participant and authority data from the validated participant;
identifying transactions-in-progress of the validated participant, the transactions-in-progress of the validated participant comprising when funds are in-transition between the at least one financial service provider (FSP) and the at least one banking service provider (BSP); and
sending a transition notification to the validated participant using the identifying transactions-in-progress of the validated participant using the participant application being executed on the computing device, the transition notification comprising a call-to-action message to the validated participant about the transactions-in-progress before the transactions are completed.

8. The system of claim 7, wherein the one-time or recurring transaction from the at least one banking service provider (BSP) comprises at least one or more of: opening a savings account in a name of the validated participant at the at least one financial service provider (FSP) using funds transferred by the at least one banking service provider (BSP) and establishing a one-off or recurring withdrawal from a checking account of the validated participant.

9. A computer-implemented method with integrated systems for one-click transactions and financial advice using one or more gateway servers, the method comprising:
exchanging cryptographic information with a mobile device associated with a prospective participant, the cryptographic information adapted to encrypt and decrypt communications;
receiving, from the prospective participant, identifying information associated with the prospective participant;
validating the identifying information using the cryptographic information;
converting the prospective participant to a validated participant after the validating operation;
receiving a plurality of data sources of the validated participant including payroll data and retirement account data of the validated participant;
sending a call-to-action message to the validated participant based on analyzing of the plurality of data sources of the validated participant including the payroll data and the retirement account data of the validated participant;
receiving feedback from the validated participant based on the call-to-action message; and
automatically implementing advice for the validated participant by automatically communicating with at least one investment service provider (ISP) and at least one payroll service provider (PSP) based on the feedback from the validated participant.

10. The method of claim 9, wherein the automatically implementing advice for the validated participant by automatically communicating with the at least one investment service provider (ISP) and the at least one payroll service provider (PSP) comprises:
sending an automatically implement advice for the participant file to the at least one investment service provider (ISP);
receiving an automatically implemented advice for the participant confirmation file from the at least one investment service provider (ISP);
sending the automatically implement advice for the participant file to the at least one payroll service provider (PSP); and
updating a transaction status of the validated participant using a participant application being executed on the mobile device.

11. The method of claim 9, wherein the receiving feedback from the validated participant based on the call-to-action message comprises a first change in a savings percentage for the retirement account data of the validated participant including a first participant feedback timestamp.

12. The method of claim 11, wherein the operations further comprise:
saving the first change in the savings percentage for the retirement account data of the validated participant including the first participant feedback timestamp in a database;
receiving a second change in the savings percentage for the retirement account data of the validated participant including a second participant feedback timestamp from the at least one investment service provider (ISP); and
comparing the first participant feedback timestamp and the second participant feedback timestamp to determine a most recent timestamp.

13. The method of claim 12, wherein the first participant feedback timestamp is the most recent timestamp determined by the comparing the first participant feedback timestamp and the second participant feedback timestamp;
wherein the automatically implementing advice for the validated participant by automatically communicating with the at least one investment service provider (ISP) and the at least one payroll service provider (PSP) comprises:
sending the first change in the savings percentage for the retirement account data of the validated participant including the first participant feedback timestamp to the at least one payroll service provider (PSP).

14. The method of claim 12, wherein the second participant feedback timestamp is the most recent timestamp determined by the comparing the first participant feedback timestamp and the second participant feedback timestamp;
wherein the automatically implementing advice for the validated participant by automatically communicating with the at least one investment service provider (ISP) and the at least one payroll service provider (PSP) comprises:
sending the second change in the savings percentage for the retirement account data of the validated participant including the second participant feedback timestamp to the at least one payroll service provider (PSP).

15. The method of claim 9, the operations further comprise:
initiating a one-time or recurring transaction from the at least one payroll service provider (PSP) by streamlining a Know-Your-Customer (KYC) process using known data of the validated participant, the known data of the validated participant including financial data of the validated participant available as a financial advisor of the validated participant and authority data from the validated participant;
identifying transactions-in-progress of the validated participant, the transactions-in-progress of the validated participant comprising when funds are in-transition between the at least one investment service provider (ISP) and the at least one payroll service provider (PSP); and
sending a transition notification to the validated participant using the identifying transactions-in-progress of the validated participant and using a participant application being executed on the mobile device, the transition notification comprising a call-to-action message to the validated participant about the transactions-in-progress before the transactions are completed.

16. The method of claim 15, wherein the one-time or recurring transaction from the at least one payroll service provider (PSP) comprises at least one or more of: opening a savings account in a name of the validated participant at the at least one investment service provider (ISP) using funds transferred by the at least one payroll service provider (PSP) and establishing a one-off or recurring withdrawal from a checking account of the validated participant.

17. A non-transitory computer-readable storage medium having embodied thereon a program, the program being executable by a processor to perform operations with integrated systems for one-click transactions and financial advice using one or more gateway servers, the operations comprising:
exchanging cryptographic information with a mobile device associated with a prospective participant, the cryptographic information adapted to encrypt and decrypt communications;
receiving, from the prospective participant, identifying information associated with the prospective participant;
validating the identifying information using the cryptographic information;
converting the prospective participant to a validated participant after the validating operation;
receiving a plurality of data sources of the validated participant including payroll data and retirement account data of the validated participant;
sending a call-to-action message to the validated participant based on analyzing of the plurality of data sources of the validated participant including the payroll data and the retirement account data of the validated participant;
receiving feedback from the validated participant based on the call-to-action message; and
automatically implementing advice for the validated participant by automatically communicating with at least one investment service provider (ISP) and at least one payroll service provider (PSP) based on the feedback from the validated participant.

18. The non-transitory computer-readable storage medium of claim 17, wherein the automatically implementing advice for the validated participant by automatically communicating with the at least one investment service provider (ISP) and the at least one payroll service provider (PSP) comprises:
sending an automatically implement advice for the participant file to the at least one investment service provider (ISP);
receiving an automatically implemented advice for the participant confirmation file from the at least one investment service provider (ISP);
sending the automatically implement advice for the participant file to the at least one payroll service provider (PSP); and
updating a transaction status of the validated participant using a participant application being executed on the mobile device.

19. The non-transitory computer-readable storage medium of claim 17, wherein the receiving feedback from the validated participant based on the call-to-action message comprises a first change in a savings percentage for the retirement account data of the validated participant including a first participant feedback timestamp;
wherein the operations further comprise:
saving the first change in the savings percentage for the retirement account data of the validated participant including the first participant feedback timestamp in a database;
receiving a second change in the savings percentage for the retirement account data of the validated participant including a second participant feedback timestamp from the at least one investment service provider (ISP); and
comparing the first participant feedback timestamp and the second participant feedback timestamp to determine a most recent timestamp.

20. The non-transitory computer-readable storage medium of claim 19, wherein the first participant feedback timestamp is the most recent timestamp determined by the comparing the first participant feedback timestamp and the second participant feedback timestamp;
wherein the automatically implementing advice for the validated participant by automatically communicating with the at least one investment service provider (ISP) and the at least one payroll service provider (PSP) comprises:
sending the first change in the savings percentage for the retirement account data of the validated participant including the first participant feedback timestamp to the at least one payroll service provider (PSP).

21. The non-transitory computer-readable storage medium of claim 17, wherein the operations further comprise:
initiating a one-time or recurring transaction from the at least one payroll service provider (PSP) by streamlining a Know-Your-Customer (KYC) process using known data of the validated participant, the known data of the validated participant including financial data of the validated participant available as a financial advisor of the validated participant and authority data f from the validated participant;
identifying transactions-in-progress of the validated participant, the transactions-in-progress of the validated participant comprising when funds are in-transition between the at least one investment service provider (ISP) and the at least one payroll service provider (PSP); and
sending a transition notification to the validated participant using the identifying transactions-in-progress of the validated participant using a participant application being executed on the mobile device, the transition notification comprising a call-to-action message to the validated participant about the transactions-in-progress before the transactions are completed; wherein the one-time or recurring transaction from the at least one payroll service provider (PSP) comprises at least one or more of: opening a savings account in a name of the validated participant at the at least one investment service provider (ISP) using funds transferred by the at least one payroll service provider (PSP) and establishing a one-off or recurring withdrawal from a checking account of the validated participant.
